(19) United States
(12) Patent Application Publication
(10) Pub. No.: US 2013/0016468 A1
(43) Pub. Date: Jan. 17, 2013

(54) WIRELESS KEYBOARD FOR TABLET PC WITH STAND

(71) Applicant: HeeBum OH, Seoul (KR)

(72) Inventor: HeeBum OH, Seoul (KR)

(73) Assignee: UNIGLOBE HNT CO., LTD., Seoul (KR)

(21) Appl. No.: 13/207,800

(22) Filed: Aug. 11, 2011

(30) Foreign Application Priority Data
Jul. 12, 2011 (KR) 10-2011-0068862

(51) Int. Cl. G06F 1/16

(52) U.S. Cl. 361/679.12

(57) ABSTRACT

The present invention is about a wireless keyboard for tablet PC, which is a kind of accessory that is necessary for using the tablet PC conveniently.

The present invention combined the role of a case that protects the tablet PC to the wireless keyboard and ensured and made the attachment and detachment of it more convenient with magnet and all. When user intends to use it, he or she can easily assemble the built-in stand of the wireless keyboard and conveniently use it.

CROSS-REFERENCE TO RELATED PATENT APPLICATION

This application claims the benefit of Korean Patent Applications No. 10-2011-0068862, filed on Jul. 12, 2011, in the Korean Intellectual Property Office, the disclosure of which is incorporated herein in its entirety by reference.

### BACKGROUND OF THE INVENTION

1. Field of the Invention

The present invention is about the structure of a wireless keyboard for tablet PC, which is one of the accessories necessary for using the tablet PC conveniently. To be more specific, it is about a wireless keyboard for tablet PC that is equipped with a stand, which has the combined use for a cover that protects tablet PC and a stand that supports tablet PC when it is attached to the wireless keyboard and used.

2. Description of the Related Art

Tablet PC is receiving the world-wide explosive popularity because it can be operated by touching the soft keys on the display without separately composing the keyboard. Strengthening the advantage of its portability due to its lightness and thinness, it is getting thinner. A protective film and smart cover made of leather or PU seat that can protect the combined display and touch panel, which is consisted of glass substrates from getting damaged in case that people drop it as they carry around are sold in the market.

Especially, in case of Apple's iPad2, the company predicted that the most of the buyers would use seat covers that protect the touch panel screen, so the company built in magnets on the one end of the tablet PC terminal and other magnets of opposite polarity on the end of the seat cover, allowing it to get automatically attached when the cover approached near the tablet PC body.

Also, a dock stand, which is a support for fixing and standing a tablet PC when using it while stayed in a certain space, is also supplied. This kind of dock stand is equipped with recess on a flat support, where tablet PC terminal could be put, however it is attached in a bit unstable state.

Meanwhile, in sales with the cover is a keyboard that is connected wirelessly like Bluetooth, which complemented the disadvantage that it is inconvenient to use unlike general PC with separate keyboard and display screen when using tablet PC while stayed in a fixed space, besides the advantage that it is convenient to use while on the move because it is simple to carry. This kind of accessory enhances the effective value of tablet PC.

However, in spite of the appearance of the aforesaid protective film, smart cover, and dock stand, it is still inconvenient to use table PC in stationary unlike the existing general PC, and there are many separate accessories that are fragmentary, so there is the necessity to provide more convenient accessory.

### SUMMARY OF THE INVENTION

Therefore, the goal of the present invention is to provide wireless keyboard for tablet PC in a new form of unifying the role of protecting the tablet PC on moving and of keyboard housing and stand, which can enhance convenience in case of using the tablet PC in the staying space.

The present invention can provide a wireless keyboard that is connected to the tablet PC terminal without wire;

the wireless keyboard comprising;

a combining bar which is attached to the one end of the aforesaid tablet PC terminal with hinge and supporting the tablet PC terminal; and

a stand which can be taken out in the method of sliding out from the inside pocket of the wireless keyboard body and can be folded in triangular section when the stand be taken out so as to support the tablet PC terminal.

Also, the present invention can provide the wireless keyboard for the tablet PC wherein the aforesaid combining bar comprises magnet, Velcro or double-sided tape.

Also, the present invention can provide the wireless keyboard for the tablet PC wherein the supporting member, which supports the end of the tablet PC terminal, is connected with the aforesaid combining bar with a pin at both end of the aforesaid combing bar, and that the aforesaid supporting member is also connected by pins with the joint member, which is connected to the main body of the wireless keyboard.

Also, the present invention can provide the wireless keyboard for the tablet PC wherein the aforesaid stand comprises upper and bottom plates;

the upper plate comprises the first and second boards;

the end of the first board of the upper plate is combined with the bottom plate with the hinge, and the other side of the first board is combined with the second board with the hinge so that the upper and bottom plates can be folded and unfolded; as the upper plate is unfolded, the first and second boards are bent to compose the triangular cross section stand.

Also, the present invention can provide the wireless keyboard for tablet PC built-in emergency battery that can supply electric power to the tablet PC.

Also, the present invention can provide the wireless keyboard for tablet PC wherein the hinge connecting the first board and the second board, equipped with torsion springs, whereby the force works for both sides at the hinge when the stand is taken out from the main body of the wireless keyboard so that the triangular cross section stand is formed automatically by the elasticity of the spring.

Also, the present invention can provide a steel band which is attached to the tablet PC and enables the wireless keyboards for tablet PC to combine the combining bar of the aforesaid wireless keyboard.

According to the present invention, in case of using a tablet PC in stationary, its terminal can be supported easily and stably when connecting the terminal and the wireless keyboard to use.

Also, according to the present invention, it can protect tablet PC terminal while moving by attaching the tablet PC terminal and wireless keyboard together easily and safely like an automatic locking terminal.

### BRIEF DESCRIPTION OF THE FIGURES

FIG. 1 shows the present invention's wireless keyboard for tablet PC.

FIG. 2 to FIG. 4 show the present invention's members that provide the supporting function for tablet PC terminal of the wireless keyboard for tablet PC in detail.

FIG. 5 to FIG. 8 are the perspective views that show the motion of taking out of the stand (FIG. 5 to FIG. 7) that is built in the wireless keyboard for tablet PC of the present invention and the state of built-in (FIG. 8).

FIG. 9 shows the picture of the tablet PC being supported by the stand that is installed in the wireless keyboard, when working with the wireless keyboard for tablet PC of the present invention.

FIG. 10 shows the state of the wireless keyboard for tablet PC of the present invention and tablet PC being combined and folded.

FIG. 11 is the perspective view that shows the installation of the torsion springs for the motion of automatic opening of the stand that is built inside the wireless keyboard for tablet PC of the present invention.

### DETAILED DESCRIPTION OF THE INVENTION

As below, the present invention's desirable embodiments will be explained in detail, referring to the attached figures.

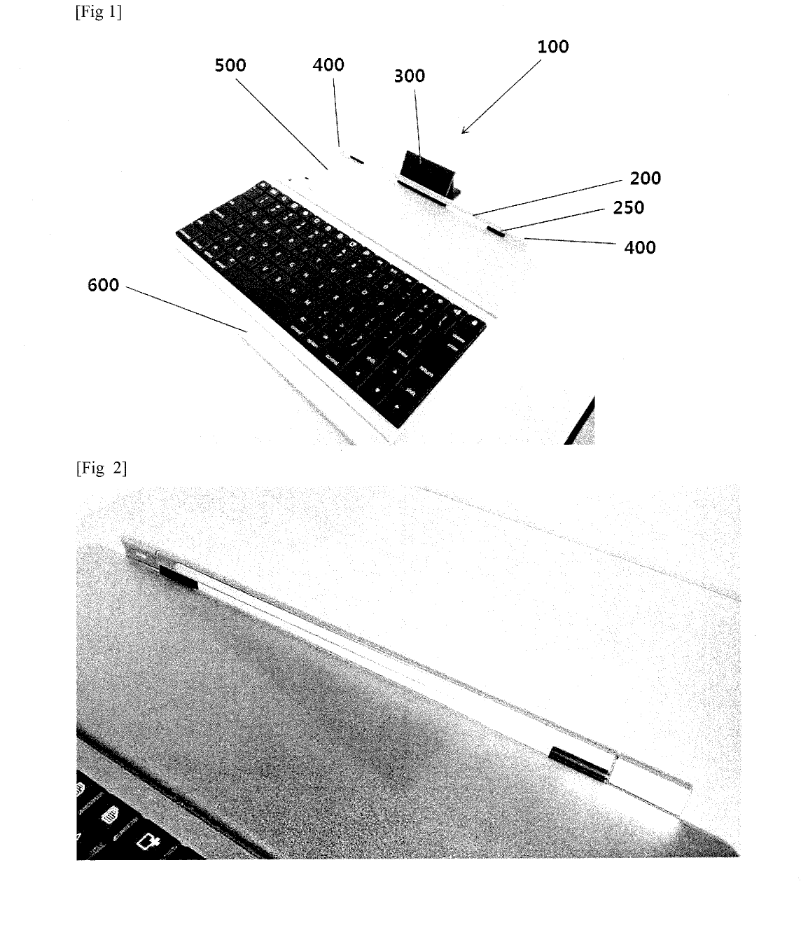

FIG. 1 shows the present invention's wireless keyboard(100) for tablet PC together with the codes that are given to the structure.

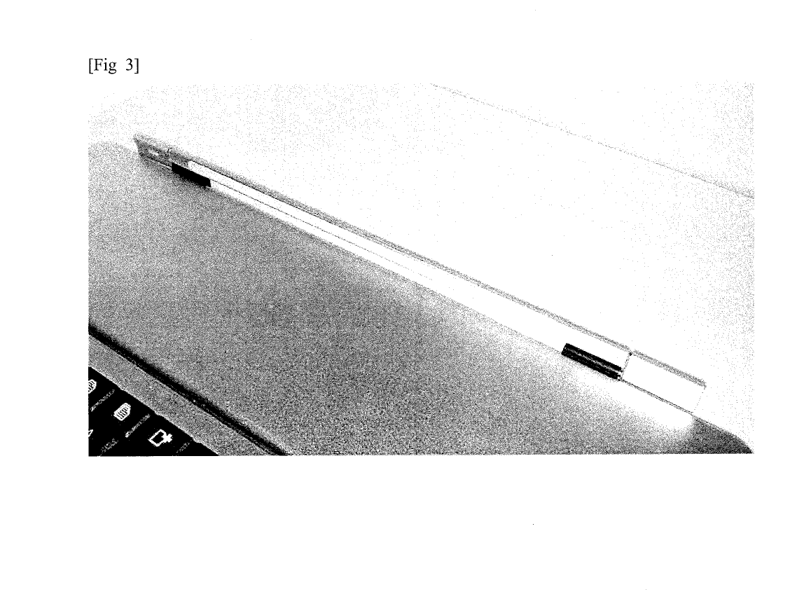

At one end of the aforesaid wireless keyboard (100), the magnet combining bar is formed long, and at the both ends, the magnet combining bar and two support members separately composed are fixed in a rotatable position. FIGS. 2 and 3 show that the aforesaid magnet combining bar (200) and supporting member (400) and supporting member (400) and joint member (250) are combined with a pin so that the magnet combining bar (200) and the supporting member (400) can rotate like hinge. One side of the aforesaid joint member (250) is combined to the main body of the wireless keyboard (100).

The aforesaid magnet combining bar(200) is made up of magnets that arranged with the polarity, so that it would work the mutual attractive interaction with the magnets built in at one end of the tablet PC terminal like Apple's iPad2. If it is applied to iPad2, it is more stable and convenient. To apply this to other manufacture companies' tablet PC terminal, steel band with double sided tape, Velcro or adhesive, can be attached on the end of a tablet PC, where the aforesaid magnet combining bar (200) touches, enable the tablet PC to receive the attraction of the magnet. Also, combing bar that double sided tape or Velcro is attached can be constructed.

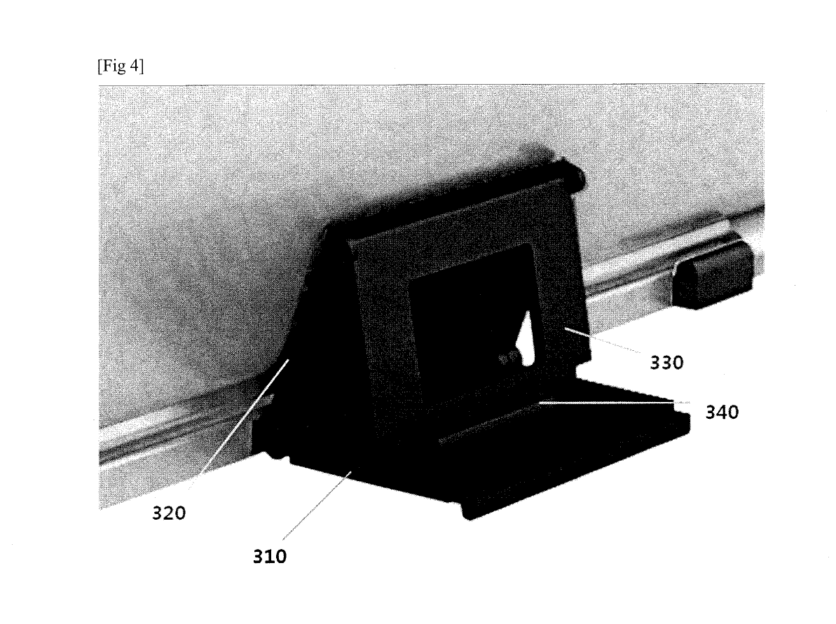

In the middle of the end of one side of the aforesaid wireless keyboard(100), the stand (300) with considerable width is built-in as a foldable state, and equipped with sliding rail, whereby it can be slidingly taken out or pushed into . Also, the aforesaid stand (300) is composed of upper and bottom (310) plates as shown in FIG. 4, and the upper plate has the first (320) and second (330) boards, which are connected at the hinge that can be folded like a limb.

In other words, as it is shown in FIG. 4, one side of the first board (320) of the upper plate is combined with the end of the bottom plate (310) at the hinge, and the first board (320) and the second board (330) are combined together at another hinge, so when they are bent like limb, the triangular cross section stand can be embodied.

At the state of forming the triangular cross section stand, the end of the second board (330) is fixed at the groove (it does not show clearly, but it is formed) created between the protrusions of the bottom plate (310). Many protrusions(340) and groove can be arranged at short intervals, allowing the adjustment of the angle of the triangular side of the stand (300).

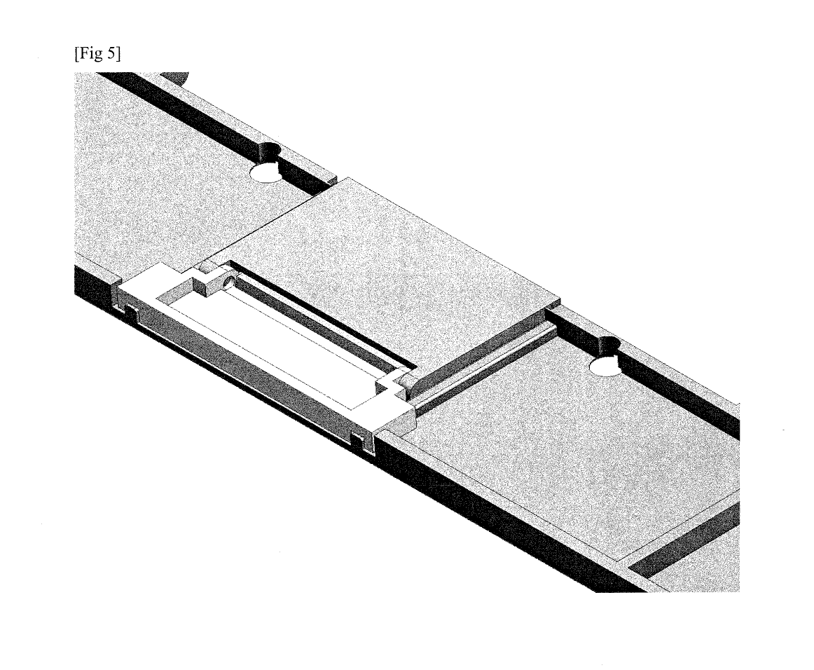

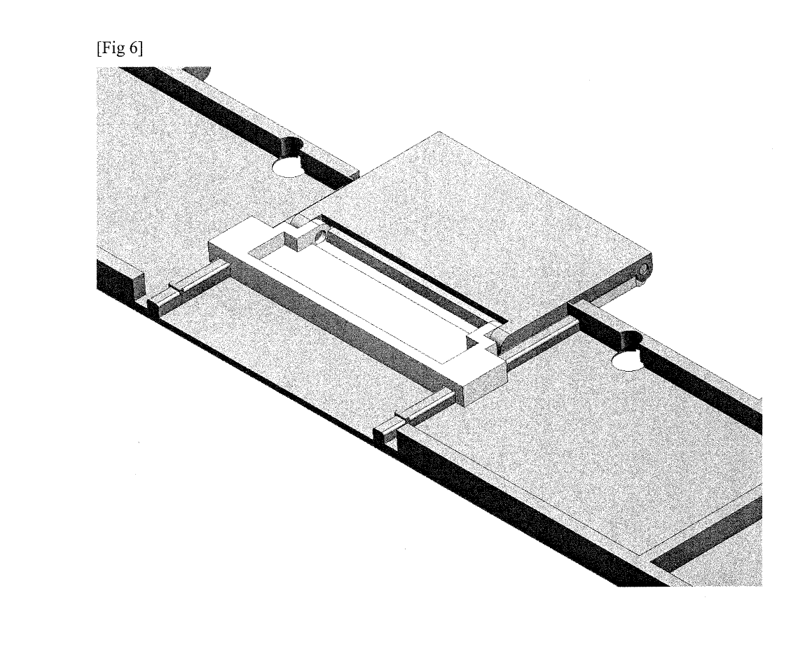

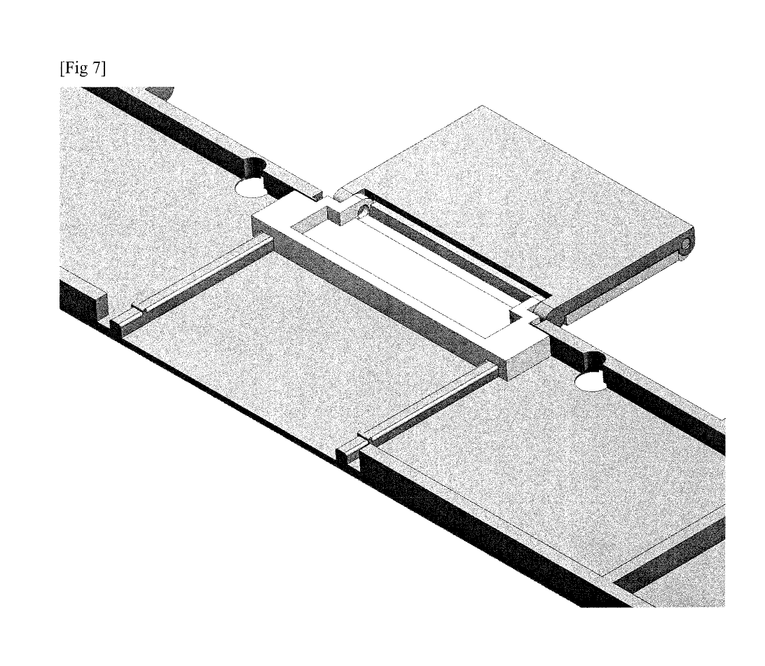

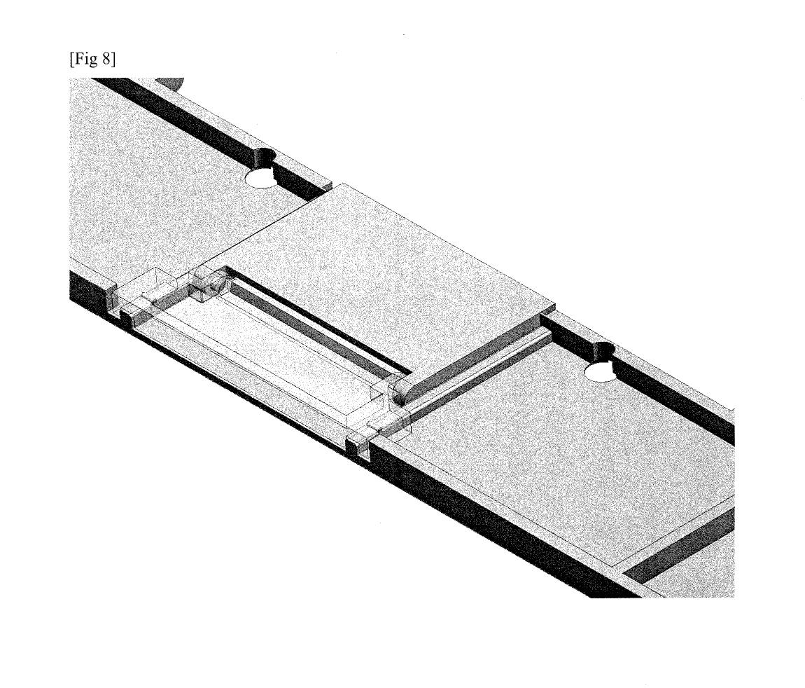

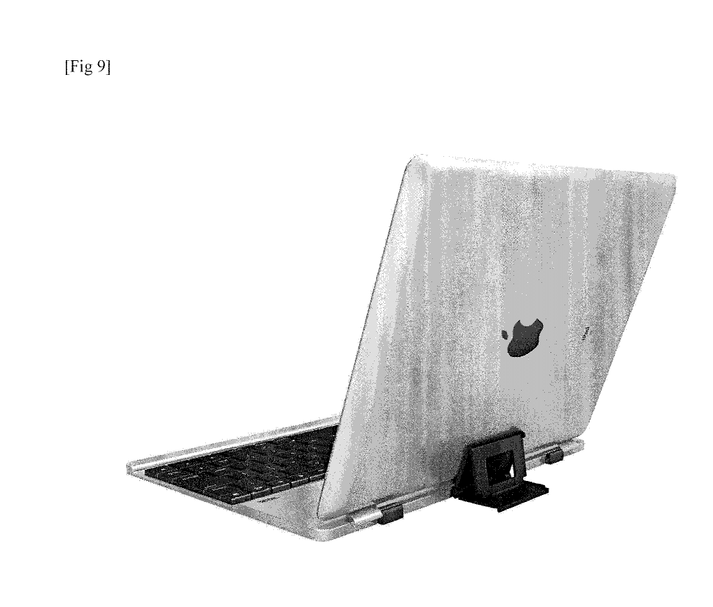

FIG. 1 to FIG. 8 showed the motion of taking out the aforesaid triangular cross section stand (Drawing 5 to 7) and built-in state (FIG. 8). FIG. 5 shows the upper plate and bottom plate of the triangular cross section stand folded upon each other and built inside the main body of the wireless keyboard. FIG. 6 shows that it is taken outside a bit, and FIG. 7 shows them completely taken out. FIG. 9 shows it returned to its original state. And the protrusion, which is protruded at the end of the sliding rail as shown in FIG. 6 and FIG. 7, enables the maintaining of the fixture of folded in state.

FIG. 9 shows the state of the tablet PC terminal being installed on the stand (300) of the present invention's wireless keyboard. The magnet combining bar (200) and iPad2 of the tablet PC, where magnet is built in at one end are attached together by the magnetic force, supported by the two supporting members (400) and can be stably held by the stand (300).

Meanwhile, wireless keyboard (100) of the present invention has a spare room for emergency battery to be built in, which can supply the power when the battery of the tablet PC is exhausted, and this is relevant to the internal section of battery in FIG. 1.

In the bottom part of the battery's internal section (500), there is high-capacity battery. Through USB port and such, jack that connects with the battery can be plugged into the power supply socket of the tablet PC terminal for use.

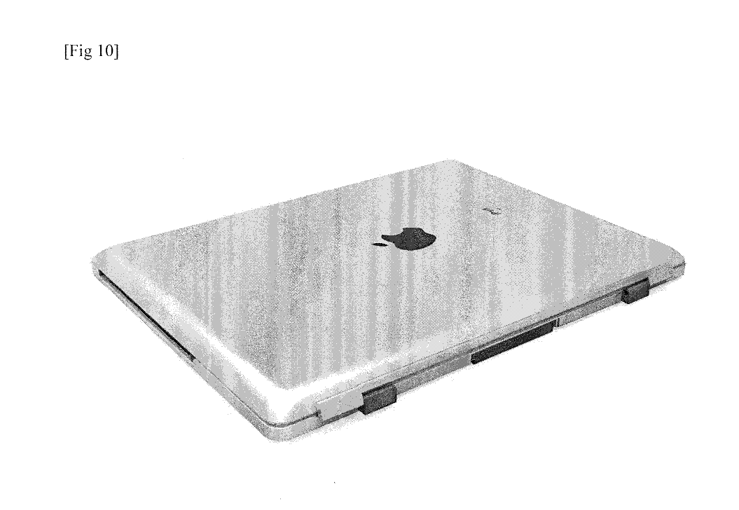

FIG. 10 shows the state of the present invention's wireless keyboard (100) and tablet PC terminal lying on top of each other and folded.

Stand (300) has its upper plate and bottom plate lying on top of each other and pushed inside in the method of sliding; the supporting member (400) and magnet combining bar (200) cover the tablet PC terminal. Stand (300) gets fixed in the state of being pushed inside when pressure is applied a little, and if it is pulled outside when taking it out, it can be composed as to let it slide out.

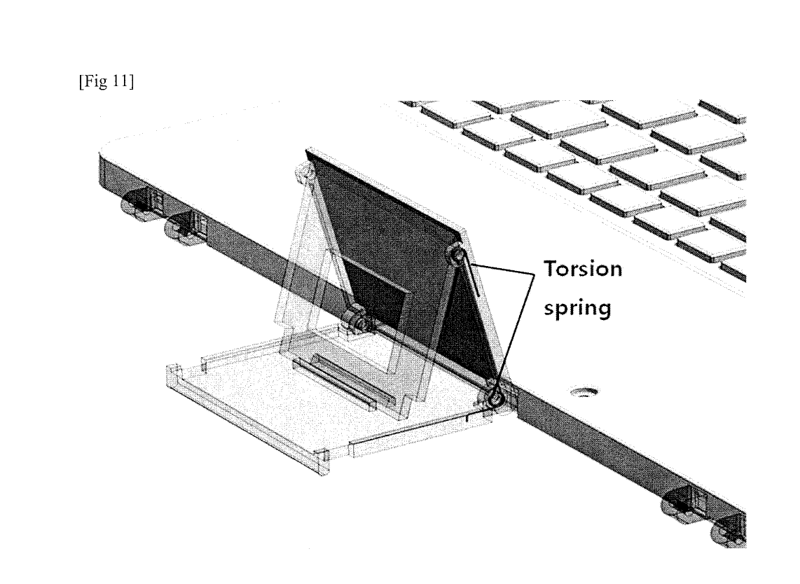

It is also desirable to make it automatically form a triangular cross section stand simultaneously with taking it out by using torsion spring to enhance convenience. In other words, if it gets released from the state of folding the upper plate and installing the torsion springs at the hinges, where the upper plate's first board (320) and second board (330) combine and the second board (330) and the bottom plate combine, then it will automatically open by the elasticity of the torsion spring (refer to FIG. 11).

In the internal section of the magnet indicated in FIG. 1, there are magnets built in. This is to have magnets built in a spare room at one end of the wireless keyboard (100), putting the polarity together by gravitation, which is to correspond to the fact that there are magnets inside the relevant part like iPad2. It is to have the effect of an automatic lock system by using the gravitation of the magnet, when the tablet PC terminal and wireless keyboard became as one, laying one on the top of the other, like FIG. 6. If it is to be moved, such device like this works highly effectively in terms of convenience and safety for protecting tablet PC.

Thus, the wireless keyboard, which has built-in stand that enables the tablet PC to be used more conveniently and stably, can be realized.

It is axiomatic that the right of the present invention is not limited to the working examples, which were explained above, but defined by what is written in the range of claims, and that the person with the general knowledge of this field can perform various changes and adapt within the range of right that is written in the range of claims.

What is claimed is:

1. A wireless keyboard that is connected to the tablet PC terminal without wire;
the wireless keyboard comprising;
a combining bar which is attached to one end of the aforesaid tablet PC terminal with hinge and supporting the tablet PC terminal; and
a stand which can be taken out in the method of sliding out from the inside pocket of the wireless keyboard body and can be folded in triangular section when the stand be taken out so as to support the tablet PC terminal.

2. The wireless keyboard for the tablet PC of claim 1 wherein the aforesaid combining bar comprises magnet, Velcro, or double sided tape.

3. The wireless keyboard for the tablet PC of claim 1 wherein the supporting member, which supports the end of the tablet PC terminal, is connected with the aforesaid combining bar with a pin at both end of the aforesaid combining bar, and that the aforesaid supporting member is also connected by pins with the joint member, which are connected to the main body of the wireless keyboard.

4. The wireless keyboard for the tablet PC of claim 1 wherein the aforesaid stand comprises upper and bottom plates;
the upper plate comprises the first and second boards;
the end of the first board of the upper plate is combined with the bottom plate with the hinge, and the other side of the first board is combined with the second board with the hinge so that the upper and bottom plates can be folded and unfolded; as the upper plate is unfolded, the first and second boards are bent to compose the triangular cross section stand.

5. The wireless keyboard for tablet PC of claim 1 built-in emergency battery that can supply electric power to the tablet PC.

6. The wireless keyboard for tablet PC of claim 4 wherein the hinge connecting the first board and the second board, equipped with torsion springs, whereby the force works for both sides at the hinge when the stand is taken out from the main body of the wireless keyboard so that the triangular cross section stand is formed automatically by the elasticity of the springs.

7. A steel band which is attached to the tablet PC and enables the wireless keyboards for tablet PC to combine the combining bar of the wireless keyboard of claim 2.
